(19) United States
(12) Patent Application Publication
(10) Pub. No.: US 2005/0082154 A1
(43) Pub. Date: Apr. 21, 2005

(54) Safety lock structure for instrument switch

(76) Inventor: Jeong-Yeon Park, Jeollabuk-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,217

(22) Filed: Dec. 30, 2003

(30) Foreign Application Priority Data
Oct. 21, 2003 (KR) 10-2003-0073399

(51) Int. Cl. H01H 9/20

(52) U.S. Cl. 200/334

(57) ABSTRACT

A safety knob is installed at a switch knob for sliding along the surface of the switch knob. A safety lock bar integrally formed at the safety knob for sliding with the safety knob, a plate spring restoring the safety lock bar to the original disposition, and a locking rod locking the safety lock bar for preventing the switch knob from being pressed unless the safety knob is manipulated is disclosed. The structure provides a facilitation of the manipulation during an emergency situation by either locking or unlocking the safety system via a driver's manual operation and/or prevention of a manipulation error of the instrument switch by operating the safety lock function in both an activated/deactivated state of the instrument switch.

### CROSS-REFERENCE TO RELATED APPLICATIONS

This application claims priority to Korean Application No. 10-2003-0073399, filed on Oct. 21, 2003, the disclosure of which is incorporated fully herein by reference.

### FIELD OF THE INVENTION

Generally, the present invention relates to a vehicle instrument switch. More particularly, to a safety lock structure for an instrument switch adapted to be activated only by a manual operation of a driver, thereby improving the stabilization of driving.

### BACKGROUND OF THE INVENTION

Typically, an instrument panel of a vehicle is mounted with a plurality of switches in order for a driver to operate various functions of the vehicle. Some switches, mounted on the instrument panel, can largely affect the driving stability by a driver's inadvertent operation. In particular, a differential lock switch, wheel lock switch, Compressed Natural Gas (CNG) main switch, kneeling switch and the like are likely to greatly influence driving stability. Thus, a safety lock device is typically equipped in the switches.

However, there is a drawback in conventional safety lock devices in that an individual tool (e.g., a key) is required to activate the safety lock device, thereby generating an inconvenience during an emergency situation. Another drawback is that the safety lock function is applied in only one state, the switch is either activated or deactivated, so that unless the safety lock function is applied, the switch can be activated inadvertently, causing a deterioration of the stabilization of driving.

### SUMMARY OF THE INVENTION

An embodiment of the present invention provides a safety lock structure for an instrument switch adapted to manipulate a safety lock function of an instrument switch by manual operation. Thereby facilitating the manipulation process in the event of an emergency situation. The safety lock function can also be carried out regardless of whether the instrument switch is in an activated state (switch-on) or a deactivated state (switch-off), thereby preventing a manipulation error of the instrument switch.

In a preferred embodiment, the safety lock structure for an instrument switch, wherein the instrument switch with a switch body repeating an activated and deactivated state in response to the depression of a switch knob, comprises a safety knob installed at the switch knob for sliding along the surface of the switch knob. A safety lock bar is integrally formed at the safety knob for sliding with the safety knob. A plate spring restores the safety lock bar to the original disposition. A locking rod locks the safety lock bar for preventing the switch knob from being pressed when the safety knob is not manipulated.

The locking rod is formed with a locking sill and a locking groove, wherein the locking sill supports the safety lock bar for preventing the switch knob from being pressed when the switch body is in a deactivated state, while the locking groove fixes the safety lock bar by insertion for preventing the switch knob from being pressed when the switch body is in an activated state.

### BRIEF DESCRIPTION OF THE DRAWINGS

For a better understanding of the nature and objects of the present invention, reference should be made to the following detailed description with the accompanying drawings, in which:

FIG. 1 illustrates a safety lock structure for an instrument switch according to an embodiment of the present invention;

FIG. 2 illustrates a safety lock structure when an instrument switch is in a deactivated state; and

FIG. 3 illustrates a safety lock structure when an instrument switch is in an activated state.

### DETAILED DESCRIPTION OF PREFERRED EMBODIMENTS

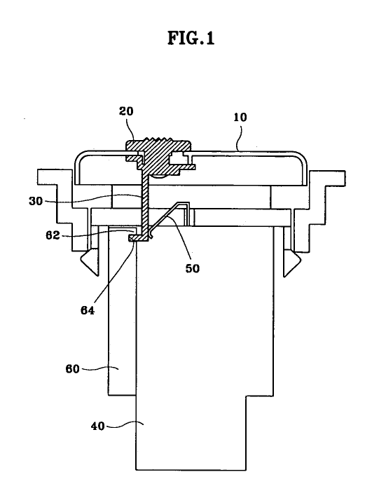

As shown in FIG. 1, a safety knob 20 is installed at a instrument switch knob 10 for sliding along the surface of the switch knob 10. A safety lock bar 30 is integrally formed at the safety knob 20 for sliding with the safety knob 20. A plate spring 50 is fixed at a lateral side of an instrument switch body 40 for restoring the safety lock bar 30 to its original disposition, in which the safety lock bar 30 slides in correspondence to a driver's sliding manipulation of the safety knob 20. The instrument switch body 40 is formed with a locking rod 60, which locks the safety lock bar 30 for preventing the switch knob 10 from being pressed unless the safety knob 20 is slidingly manipulated.

The locking rod 60 is formed with a locking sill 62 and a locking groove 64, wherein the locking sill 62 supports the safety lock bar 30 for preventing the switch knob 10 from being pressed when the instrument switch body 40 is in a deactivated state. The locking groove 64 fixes the safety lock bar 30 by insertion for preventing the switch knob 10 from being pressed when the instrument switch body 40 is in an activated state.

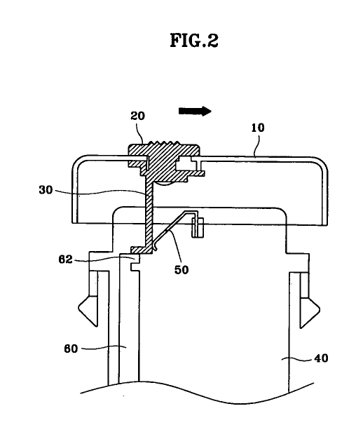

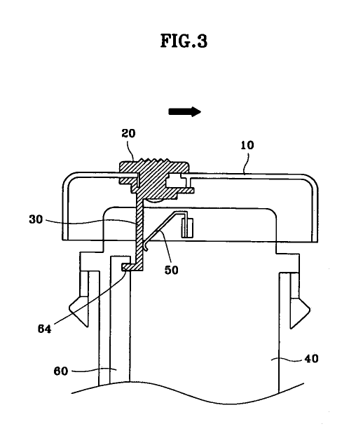

The operation and effect of the safety lock structure for the instrument switch will now be described in detail with reference to FIGS. 2 and 3. As shown in FIG. 2, when the instrument switch is in a deactivated state, the switch knob 10 is projected to the inside passenger compartment, and the safety lock bar 30 is placed on the locking sill 62 of the locking rod 60, thus the switch is not operated even if the driver presses the switch knob 10. In order for the driver to operate the switch knob 10 when the instrument switch is in a deactivated state, the safety knob 20 should be shifted along the arrow and simultaneously depressed. When the switch is activated (switch-on) by the manipulation described above, the safety knob 20 is restored to its original disposition via the plate spring 50.

As shown in FIG. 3, when the instrument switch is in an activated state, the switch knob 10 is in a pressed state toward the inner side of the switch body 40, and the safety lock bar 30 is inserted into the locking groove 64 of the locking rod 60, thus the switch is not operated even if the driver presses the switch knob 10. In order for the driver to operate the switch knob 10 when the instrument switch is in an activated state, the safety knob 20 should be shifted in the direction of the arrow and simultaneously depressed. After the switch is deactivated (switch-off) by the manipulation described above, the safety knob 20 is restored to its original disposition by the plate spring 50.

As apparent from the foregoing, there is an advantage in the safety lock structure for an instrument switch adapted to manipulate a safety locked or unlocked state of the instrument switch by manual operation, thereby facilitating the manipulation during an emergency situation. The safety lock function can also be carried out regardless of whether the instrument switch is in an activated state or a deactivated state, thereby preventing a manipulation error of the instrument switch.

1. A safety lock structure for an instrument switch, wherein the instrument switch includes a switch body repeating an activated and deactivated state in response to the depression of a switch knob, comprises:
a safety knob installed at said switch knob for sliding along the surface of said switch knob;
a safety lock bar integrally formed at said safety knob for sliding with said safety knob;
a plate spring restoring said safety lock bar to the original disposition; and
a locking rod locking said safety lock bar for preventing said switch knob from being pressed when said safety knob is not manipulated.

2. The structure as defined in claim 1, wherein said locking rod is formed with:
a locking sill supporting said safety lock bar for preventing said switch knob from being pressed when said switch body is in a deactivated state; and
a locking groove fixing said safety lock bar by insertion for preventing said switch knob from being pressed when said switch body is in an activated state.
